(19) United States
(12) Patent Application Publication
(10) Pub. No.: US 2026/0266696 A1
(43) Pub. Date: Sep. 10, 2026

(54) TEST BENCH ARRANGEMENT, TEST AND EVALUATION DEVICE, AND METHOD FOR CALIBRATING BEARING TEST BENCHES

(71) Applicant: Schaeffler Technologies AG & Co. KG, Herzogenaurach (DE)

(72) Inventors: Hermann Reichelt, Elfershausen (DE); Andreas Staudigel, Schweinfurt (DE); Patrick Moehrlein, Ebelsbach (DE); Stephan Noeth, Euerbach (DE); Klaus Koenig, Mühlhausen (DE)

(73) Assignee: Schaeffler Technologies AG & Co. KG, Herzogenaurach (DE)

(21) Appl. No.: 19/166,082

(22) PCT Filed: Apr. 11, 2024
(86) PCT No.: PCT/DE2024/100304

§ 371 Date: Sep. 17, 2025

(30) Foreign Application Priority Data
Apr. 13, 2023 (DE) 10 2023 109 271.5
Apr. 8, 2024 (DE) 10 2024 109 694.2

(51) Int. Cl. G01M 99/00; G01M 13/04

(52) U.S. Cl. CPC G01M 99/007; G01M 13/04

(57) ABSTRACT

The disclosure relates to a test and evaluation device for calibrating bearing test benches, comprising a plurality of bearing test benches, each of which is designed as a friction test bench for testing a rotary bearing having two bearing rings. The test and evaluation device also comprises data capture devices assigned to the individual bearing test benches and linked to a common data processing unit that is designed to compare specific properties of the bearing test benches with one another.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2024/100304, filed on Apr. 11, 2024, designating the United States of America, which in turn claims the benefit of priority under 35 U.S.C. §§ 119, 365 of German Patent Application No. 102023109271.5, filed on Apr. 13, 2023, and German Patent Application No. 102024109694.2, filed on Apr. 8, 2024, the contents of which are relied upon and incorporated herein by reference in their entirety.

### FIELD OF THE DISCLOSURE

The disclosure generally relates to a test and evaluation device which is intended for calibrating bearing test benches, wherein the bearing test benches are friction test benches for testing rotary bearings, in particular rolling bearings, for example wheel bearings. The disclosure further relates to a method for calibrating such bearing test benches. Furthermore, the disclosure also relates to a test bench arrangement comprising a bearing test bench and a rolling bearing to be tested with said bearing test bench as a test specimen.

### BACKGROUND OF THE DISCLOSURE

WO 2019/170186 A1 discloses a test bench and a method for testing a bearing arrangement. In particular, the bearing arrangement can be a rolling bearing for a wind turbine. WO 2019/170186 A1 assumes that natural facts exist which have a fundamental influence on the operation of the bearing as a whole. Based on this consideration, the definition of environmental scenarios that influence the service life of the bearing is proposed. This leads to different load scenarios related to the bearing arrangement, which are mapped to shortened test scenarios in order to minimize the test duration. In the case of WO 2019/170186 A1, roller bearings in particular are tested.

Devices for testing rolling bearings, which also include tilting moments in the test, are described, for example, in the documents DE 10 2008 060 762 A1 and WO 2015/185713 A1.

Devices for testing rolling bearings, which also include tilting moments in the test, are described, for example, in the documents DE 10 2008 060 762 A1 and WO 2015/185713 A1.

Various test bench arrangements are shown in the documents DE 10 2013 106 779 A1 and EP 2 264 421 B1. In the latter case, an electric machine is intended for driving and/or loading a test specimen.

U.S. Pat. No. 2,944,417 A shows a test bench designed for measuring procedures running over longer periods of time, in which brake shoes act on a rotating shaft. The device according to U.S. Pat. No. 2,944,417 A is specifically designed for testing the friction properties of chemically treated metallic surfaces.

The present disclosure further develops devices and methods for testing bearings, in particular testing rolling bearings, compared to the cited prior art, wherein a particularly favorable relationship is sought between equipment costs on the one hand and the accuracy and reproducibility of tests, even when numerous measuring procedures are carried out according to a uniform test scheme with multiple, similar or different devices, on the other hand.

### SUMMARY OF THE DISCLOSURE

According to the disclosure, a test and evaluation device enables the calibration of bearing test benches. The bearing test benches can in particular be test benches with which tests are carried out on unsealed, play-free double-row rolling bearings, in particular wheel bearings. The disclosure also provides a test bench arrangement constructed, which comprises a bearing test bench designed as a friction test bench and a rolling bearing as the test specimen.

Furthermore, the disclosure provides a method designed for calibrating bearing test benches designed as friction test benches. The designs and advantages of the disclosure explained below in connection with the calibration method also apply, mutatis mutandis, to the devices, i.e., the test and evaluation device, the test bench arrangement and the individual test benches, and vice versa.

The test and evaluation device according to the disclosure comprises a plurality of identical or different bearing test benches, each of which is designed as a friction test bench for testing a rotary bearing having two bearing rings. Furthermore, the test and evaluation device comprises data capture devices which are assigned to the individual bearing test benches and linked to a common centrally or decentrally constructed data processing unit, which is also assigned to the test and evaluation device and designed to compare specific properties of the bearing test benches with one another.

In particular, one of the bearing test benches can be provided as a reference test bench, which can be operated with a standardized test bearing. The test bearing can, for example, be a rolling bearing. The same rolling bearing or a rolling bearing of the same type can be subjected to tests on at least one other bearing test bench in order to test its properties in the context of a calibration with the reference test bench.

The bearing test benches, which are to be calibrated, enable the testing of rolling bearings in particular, but can also be intended for the testing of plain bearings. In both cases, tests under load, such as axial and/or radial test loads, can be provided. Tests can also be carried out on the bearings with no load present.

In all cases, a first bearing ring of the bearing can be held by a receptacle of the bearing test bench, while a hysteresis brake, also provided by the bearing test bench, acts on the second bearing ring. A torque introduced into the receptacle can be detected by use of a measuring device, which is coupled to the aforementioned data capture device or integrated into such a device.

According to various possible designs, the bearing test bench comprises a compressed air-operated lubrication device with which the rotary bearing is lubricated during the test. The lubrication device is designed to supply lubricant in a finely distributed manner in the form of an air-oil lubrication to the rotary bearing, in particular rolling bearing, with the aid of a compressed air flow. As regards possible forms of air-oil lubrication, reference is made to the documents DE 10 2004 006 313 B4, WO 2015/185713 A1, DE 000SC014461MAZ and WO 2012/010566 A1 which are hereby incorporated herein by reference. In the present case, a lubricant is supplied to the rotary bearing to be tested either continuously or discontinuously by use of air-oil lubrication.

The lubrication device, which is designed for oil mist lubrication, makes a significant contribution to ensuring that the bearing runs under largely constant, defined conditions throughout the entire test, even over a longer period of time, and thus excellently complements the hysteresis brake, which enables fine adjustment of the braking torque acting on the bearing ring. As regards possible designs of hysteresis brakes, reference is made, for example, to documents U.S. Pat. No. 6,257,380 B1, WO 96/01779 A1 and EP 0 960 467 B1 which are hereby incorporated herein by reference.

There are no fundamental restrictions regarding the size of the bearing to be tested when calibrating different bearing test benches, or regarding the speeds and forces acting on the bearing. If the bearing is designed as a rolling bearing, it can be a single-row or multi-row bearing, in particular a play-free bearing.

The method according to the disclosure offers, in particular, the possibility of carrying out a dynamic calibration of rolling bearing friction test benches that can be operated at any location and are not necessarily of the same design. The properties of the test benches determined during the calibration of the bearing test benches can be used to adapt the parameters with which the test benches in question are operated, if necessary. Such an adaptation can, in principle, be carried out either automatically or by operating personnel.

For calibrating the bearing test benches, which can also be provided by various manufacturers, play-free rolling bearings are particularly suitable, as their friction properties hardly change. For example, double-row angular contact ball bearings in an O arrangement with a preload in the order of magnitude of 10 μm to 20 μm are used as rolling bearings.

The disclosure is based on the consideration that different basic designs of rolling bearing test benches have specific advantages and disadvantages. For example, test bench types that use three-ring bearings as support bearings have generally proven useful. In comparison, test benches that have a hydrostatic support bearing are characterized by particularly low-friction operation, but emit heat into the test bearing. It is also possible in principle to measure a friction torque without load and without support bearings. In all cases, the different heat dissipation from test bench to test bench can make it difficult to calibrate the test benches.

In the solution according to the disclosure, a comparison between different test benches is made easier in particular by the fact that the lubricant flow supplied to the bearing, in particular the rolling bearing, with the aid of compressed air is guided out the bearing again, so that an easily reproducible state is achieved.

In general, the concept for testing rolling bearings implemented within the framework of the method according to the disclosure is characterized in that a torque, such as a drag torque, is introduced into a first bearing ring of the rolling bearing by means of a hysteresis brake, while lubricant, in particular oil, is supplied to the rolling bearing by means of compressed air and a torque supporting a second bearing ring of the rolling bearing is measured.

Thanks to the temperature being kept at least approximately constant with the help of lubrication, the friction torque inherent in the rolling bearing remains stable even under load. To ensure the unhindered discharge of lubricant from the rolling bearing, the bearing is operated in the test bench without seals in an advantageous method. Instead of seals, cover plates can be used, which leave an air gap between the rotating and non-rotating bearing parts.

The dissipation of heat from the rolling bearing is achieved in particular by the compressed air used to guide lubricating oil into the rolling bearing. The amount of lubricating oil carried by the compressed air can be adjusted as required, for example to one drop of oil per minute. Overall, the lubrication device is designed as a so-called drip lubricator. This can, for example, be operated with compressed air that is below an overpressure of 5 bar.

The inner ring of the bearing used in the test bench, for example a double-row ball bearing, is carried by a spindle which is subjected to a braking torque that can be adjusted with a high degree of precision by use of the hysteresis brake, in particular a precision hysteresis brake. A precision energizing unit, which enables the generation of a precisely defined magnetic field, contributes in particular to the precise adjustability of the hysteresis brake. The hysteresis brake can be designed in conjunction with the rolling bearing to be tested in such a way that at most a small heat flow is transferred from the hysteresis brake to the rolling bearing. In particular, the material flow that is guided through the rolling bearing with the help of the lubrication device can contribute to minimizing the heat transfer to the rolling bearing.

For example, a current-controlled precision laboratory power supply is suitable for energizing the hysteresis brake. This allows a constant, stable excitation current to be generated even when temperatures change.

In addition to the current with which the hysteresis brake is operated, the direction from which the current is changed can also be detected. As far as the lubrication device is concerned, in particular the air pressure and the amount of lubricant, i.e., the amount of oil delivered by the lubrication device, can be recorded during the operation of the bearing test bench. Furthermore, the detection of the speed and the temperature of the bearing can be provided.

The test bench arrangement according to the application comprises a bearing test bench, designed as a friction test bench, and a rolling bearing as the test specimen, wherein the bearing test bench has a hysteresis brake coupled to a bearing ring of the test specimen. Furthermore, the bearing test bench has a compressed air-operated lubrication device for lubricating the test specimen by air-oil lubrication. This lubrication device is not only designed to supply an air-oil mixture to the test specimen, but also enables the permanent discharge of the lubricant flow supplied to the test specimen by compressed air. The test specimen used in the test bench arrangement and enabling a calibration of test benches is a play-free multi-row, in particular double-row, unsealed rolling bearing.

Overall, the acquired data can be integrated into a measurement data acquisition strategy that is applied uniformly across a number of bearing test benches. This enables a test bench calibration that goes far beyond static calibration.

The bearing test bench is designed, for example, for performing measurements on wheel bearings for motor vehicles. Alternatively, variants of the bearing test bench can be realized in which larger bearings are tested, in particular for stationary applications.

### BRIEF DESCRIPTION OF THE DRAWINGS

In the following, an exemplary embodiment of the disclosure is explained in more detail with reference to drawings. The figures show the following in an, in parts, roughly simplified manner:

FIG. 1 is a schematic diagram illustrating a bearing test bench and roller bearing; and

FIG. 2 is a schematic block diagram illustrating a symbolic representation of a test and evaluation device intended for calibrating test benches, which comprises the bearing test bench according to FIG. 1, and a further bearing test bench.

### DETAILED DESCRIPTION

A bearing test bench 1 is intended for testing a bearing 2, which in this case is a wheel bearing for a passenger car that has been specially modified for the test. The central axis, designated MA, of the bearing 2, i.e., the test specimen, also represents the central axis of the bearing test bench 1. In the example, the central axis MA is aligned horizontally, but this is not mandatory in other examples. The bearing test bench 1 is also referred to as the reference test bench, while the bearing 2 is also referred to as the reference bearing. A test and evaluation device, designated overall by 21, serves to calibrate properties of the reference test bench 1 with properties of another bearing test bench 21, which in the present case has a design that differs from the reference test bench 1.

The bearing 2 is designed as a double-row rolling bearing, the rows of rolling elements 3, 4 of which are arranged in an O-arrangement in the bearing 2. An outer ring of the bearing 2 is designated 6, and an inner ring is designated 7. In a known embodiment, a multi-part design of the bearing rings 6, 7 is possible. The bearing 2 is designed to absorb axial forces, radial forces, and tilting loads. A cage for guiding the rolling elements 5, i.e., the balls, may be included but is not shown. In contrast to the state in which it is placed on the market, the rolling bearing 2 is not sealed.

For lubricating the bearing 2 in the bearing test bench 1, a lubrication device 8 is provided which introduces lubricant, namely oil, through the stationary outer ring 6 into the bearing interior, i.e., between the two rows of rolling elements 3, 4, with the aid of compressed air. In this way, an air-oil lubrication, i.e., an oil mist lubrication, of the bearing 2 is realized.

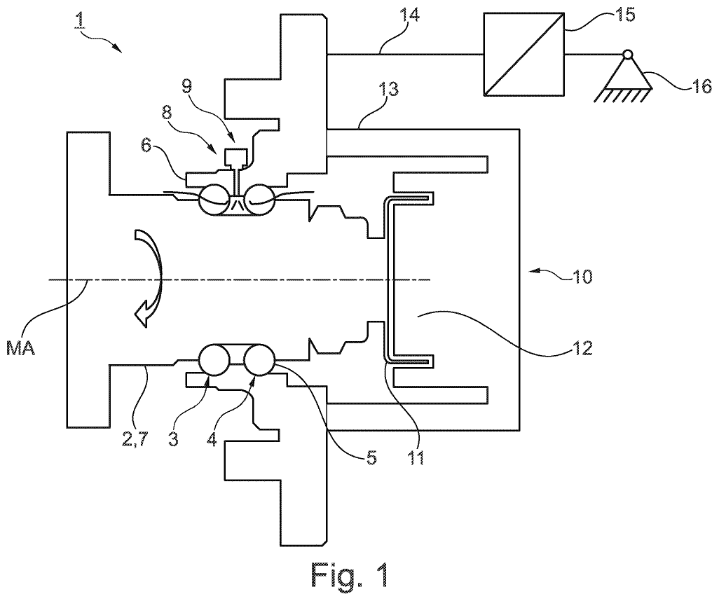

The lubrication device 8 is designed as a drip lubricator operated with compressed air. A compressed air connection of the lubrication device 8 provided for this purpose is designated 9. According to one example, the oil mist lubrication realized with the lubrication device 8 consumes 1 drop of oil per minute and is operated with a pressure of 5 bar, which is applied to the compressed air connection 9. Oil mist can leave the bearing 2 at its end faces, as indicated in the upper area of the rolling bearing in FIG. 1. Instead of the absent seals, cover plates (not shown in FIG. 1) are present which leave a 0.2 mm wide air gap. In contrast to seals, the cover plates do not have a braking effect. Due to the lack of seals, no overpressure or negative pressure can build up in the bearing 2 during test bench operation.

In order to brake the rotating bearing ring 7, i.e., the inner ring, in a defined manner, the bearing test bench 1 has a hysteresis brake 10. The hysteresis brake 10 is designed as an electronically controlled drag device. The hysteresis brake 10 has a rotor, designated 11, which is connected in a rotationally fixed manner to the inner ring 7. The associated stator of the hysteresis brake 10, designated 12, is mechanically coupled to the outer ring 6 via a holder 13. The holder 13 supports a torque which is introduced into the outer ring 6 of the rolling bearing 2 during operation.

A measuring device 15 is provided for measuring this supported torque, wherein a mechanical connecting part between the outer ring 6 and the measuring device 15 is designated 14. Unlike the simplified representation illustrated in FIG. 1, the connecting part 14 can be located between the outer ring 6 and the holder 13, also referred to as the receptacle, wherein the measuring device 15 converts forces acting on the connecting part 14, or deformations of the connecting part 14 caused by such forces, into electrical signals which are further processed in digital form.

The measuring device 15 is supported, as shown in FIG. 1, on a surrounding structure 16, which is not necessarily part of the bearing test bench 1. The drag torque, which is generated by the hysteresis brake 10 at a defined level, acts in the same direction as the friction torque of the rolling bearing 2. The lubrication device 8 is adjusted such that the bearing 2 is operated at a constant temperature level throughout the entire test procedure.

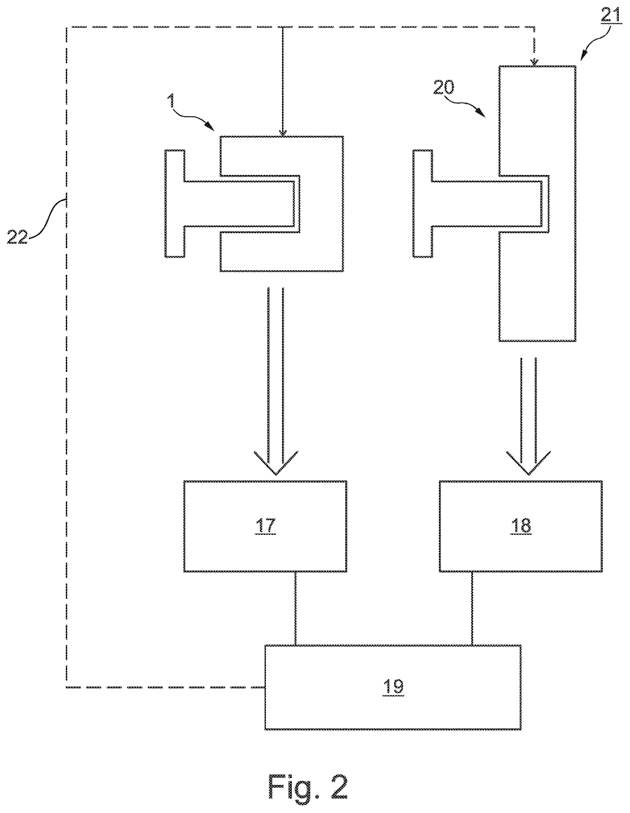

Regarding the structure of the test and evaluation device 21 as a whole, reference is made to FIG. 2. Accordingly, each of the bearing test benches 1, 21 which are to be calibrated are assigned a data capture device 17, 18. The measuring devices 15 (not shown separately in FIG. 2) are part of the respective data capture devices 17, 18.

The data capture devices 17, 18 are linked to a data processing unit 19, wherein the division into two data capture devices 17, 18 and a single data processing unit 19 shown in FIG. 2 is to be understood functionally and does not imply any statement about the actual positioning and separation or combination of data processing components.

In any case, the data processing unit 19 performs a calibration of the measurements carried out with the different bearing test benches 1, 21. This calibration serves in particular to detect deviations of the properties of the bearing test bench 21 from the properties of the reference test bench 1.

As further illustrated in FIG. 2, data lines 22 are provided, with which the bearing test benches 1, 21 are linked to the data processing unit 19. This makes it possible, in particular, to use the results of the measurements taken during operation of the various bearing test benches 1, 21 to readjust the operating parameters for future operation of the bearing test benches 1, 21. This particularly applies to the bearing test bench 21. In a manner not shown, the reference test bench 1 can be used to carry out a calibration with any number of additional bearing test benches 20.

### LIST OF REFERENCE SYMBOLS

1 Bearing test bench, reference test bench
2 Bearing, rotary bearing, rolling bearing, test specimen
3 Row of rolling elements
4 Row of rolling elements
5 Ball, rolling elements
6 Outer ring
7 Inner ring
8 Lubrication device
9 Compressed air connection
10 Hysteresis brake
11 Rotor
12 Stator
13 Receptacle
14 Mechanical connecting part
15 Measuring device
16 Surrounding structure
17 Data capture device
18 Data capture device
19 Data processing unit
20 Bearing test bench
21 Test and evaluation device
22 Data line
MA Central axis

1. A test and evaluation device for calibrating bearing test benches, the test and evaluation device comprising:
a plurality of bearing test benches, each of which is designed as a friction test bench for testing a rotary bearing having two bearing rings;
data capture devices which are assigned to the individual bearing test benches; and
a common data processing unit linked to the capture devices and designed to compare specific properties of the bearing test benches with one another.

2. The test and evaluation device according to claim 1, where at least one of the bearing test benches has a receptacle for holding the first bearing ring, a hysteresis brake for braking the second bearing ring, and a measuring device for measuring the torque introduced into the receptacle.

3. The test and evaluation device according to claim 2, wherein at least one of the bearing test benches has a compressed air-operated lubrication device for lubricating the rotary bearing by air-oil lubrication.

4. The test and evaluation device according to claim 1, wherein the test and evaluation device is configured to perform tests by use of the bearing test benches on a play-free, unsealed double-row rolling bearing.

5. A test bench arrangement comprising:
a rolling bearing as a test specimen, wherein the test specimen is designed as a play-free, multi-row, unsealed bearing; and
a bearing test bench designed as a friction test bench, wherein the bearing test bench has a hysteresis brake coupled to a bearing ring of the test specimen, and a compressed air-operated lubrication device intended for lubricating the test specimen by air-oil lubrication, which is designed for permanently discharging the lubricant flow supplied to the test specimen by compressed air.

6. A method for calibrating bearing test benches designed as friction test benches, wherein similar or identical rotary bearings, each comprising two bearing rings, are tested by use of the bearing test benches by introducing a torque into one of the two bearing rings by use of a hysteresis brake, while a torque supporting the other bearing ring is measured, and wherein specific properties of the bearing test benches detected during the testing of the rotary bearings are compared with one another.

7. The method according to claim 6, wherein at least one of the bearing test benches lubricant is supplied to the rotary bearing with compressed air in the sense of oil-air lubrication.

8. The method according to claim 7, wherein the lubricant flow supplied by compressed air is permanently discharged from the rolling bearing.

9. The method according to either one of claim 6, wherein during the test, the speed and temperature of the rolling bearing are also recorded.

10. The method according to claim 9, wherein the temperature of the rolling bearing is kept constant by the supplied lubricant.

11. The test and evaluation device according to claim 1, wherein at least one of the bearing test benches has a receptacle for holding the first bearing ring, a hysteresis brake for braking the second bearing ring, and a measuring device for measuring the torque introduced into the receptacle.

12. The test and evaluation device according to claim 1, wherein the rotary bearing comprises a play-free, unsealed double-row rolling bearing.

13. The test bench arrangement according to claim 7, further comprising a data capture device assigned to the bearing test bench and linked to a data processing unit.
